(19) United States
(12) Patent Application Publication
(10) Pub. No.: US 2020/0038711 A1
(43) Pub. Date: Feb. 6, 2020

(54) GOLF BALL

(71) Applicant: Sumitomo Rubber Industries, Ltd., Kobe-shi (JP)

(72) Inventors: Kai HAYASHI, Kobe-shi (JP); Masatoshi YOKOTA, Kobe-shi (JP)

(73) Assignee: Sumitomo Rubber Industries, Ltd., Kobe-shi (JP)

(21) Appl. No.: 16/653,679

(22) Filed: Oct. 15, 2019

Related U.S. Application Data
(63) Continuation of application No. 15/842,122, filed on Dec. 14, 2017.

(30) Foreign Application Priority Data
Dec. 26, 2016 (JP) 2016-251707

(51) Int. Cl. A63B 37/00; C08K 5/00; C08K 5/098; C08K 3/22; C08K 9/10; C08L 91/00; A63B 43/00

(52) U.S. Cl. CPC A63B 37/0024; A63B 37/0074; C08K 5/0041; C08K 5/098; C08K 5/14; C08K 9/10; C08L 91/00; A63B 43/008; C08K 5/005; C08K 3/22

(57) ABSTRACT

A golf ball including a core and a cover covering the core, wherein the cover is formed from a cover resin composition containing a first base resin and a fluorescent pigment, the first base resin contains at least one resin selected from the group consisting of a polyurethane resin, an ionomer resin and a polyamide resin, the fluorescent pigment is a dispersion having a fluorescent dye dispersed in a second base resin, and the second base resin contains at least one resin selected from the group consisting of a benzoguanamine resin, an acrylic resin and a polyester resin, and a constituent member of the golf ball other than the cover does not contain a fluorescent pigment and/or a fluorescent dye.

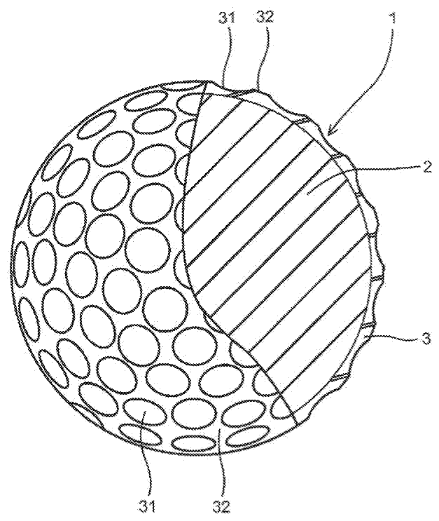

### CROSS-REFERENCE TO RELATED APPLICATIONS

This application is a Continuation of U.S. patent application Ser. No. 15/842,122 filed on Dec. 14, 2017, which claims the benefit of priority to Japanese Patent Application No. 2016-251707 filed on Dec. 26, 2016, all of which are hereby expressly incorporated by reference into the present application.

### FIELD OF THE INVENTION

The present invention relates to a golf ball, particularly a color golf ball comprising a cover containing a fluorescent pigment.

### DESCRIPTION OF THE RELATED ART

Generally, a golf ball has a white color. In case of a bad weather such as rain, cloud, fog and dim conditions, it is difficult to follow the trajectory of a white golf ball and visually recognize the spot where the golf ball falls. Moreover, when a white golf ball stops on withered lawn, it is difficult to find the golf ball even if the golf ball is just nearby. In addition, recently, golf players desiring fashionability on a golf ball are increasing. In view of the above problems, a color golf ball has been proposed to satisfy the requirements of fashionable appearance and good visibility in a bad weather.

Conventionally, a color golf ball is colored by blending a pigment or dye in a material for forming a cover. However, if the pigment or dye is not sufficiently dispersed, color unevenness tends to occur in the formed cover. Thus, a technology for suppressing such color unevenness has been proposed. For example, Japanese Patent Publication No. 2014-128666 A discloses a golf ball comprising a core and a cover of at least one layer encasing the core, wherein an outermost layer of the cover is formed of a resin composition comprising: (A) a thermoplastic resin, and (B) a color masterbatch, which color masterbatch (B) includes (b-1) a thermoplastic resin, (b-2) a colorant, (b-3) titanium oxide, (b-4) a fatty acid metal salt, and (b-5) a dispersant, component (b-4) being included in an amount of from 0.3 to 1.4 parts by weight per 100 parts by weight of component (A) and component (b-1) combined, the ratio (B)/(A) of the specific gravity of component (A) to the specific gravity of component (B) being from 0.8 to 1.2, and component (A) and component (b-1) having weight-average molecular weights (Mw) of at least 100,000 (refer to claim 1 of Japanese Patent Publication No. 2014-128666 A).

### SUMMARY OF THE INVENTION

In case of blending the pigment in the material for forming the cover, the fixation of the pigment to the base resin of the cover is poor, and thus the color development is instable after a lapse of long time since forming the cover. The present invention has been achieved in view of the above problems. An object of the present invention is to provide a golf ball comprising a cover excellent in color development over a long period of time.

The present invention that has solved the above problems provides a golf ball comprising a core and a cover covering the core, wherein the cover is formed from a resin composition containing a first base resin and a fluorescent pigment, the fluorescent pigment is a dispersion having a fluorescent dye dispersed in a second base resin, and an absolute value (|SP1-SP2|) of a difference between a solubility parameter value (SP1) ((cal/cm³)^{0.5}) of the first base resin and a solubility parameter value (SP2) ((cal/cm³)^{0.5}) of the second base resin is 6 or less. If the absolute value (|SP1-SP2|) of the difference is 6 or less, the fixation of the fluorescent pigment to the base resin of the cover is good and thus the color development over a long period of time improves.

The first base resin preferably has the solubility parameter value (SP1) in a range from 9 (cal/cm³)^{0.5} to 11 (cal/cm³)^{0.5}, and the second base resin preferably has the solubility parameter value (SP2) in a range from 6 (cal/cm³)^{0.5} to 16 (cal/cm³)^{0.5}. The resin composition for forming the cover preferably contains at least one resin selected from the group consisting of a polyurethane resin, an ionomer resin and a polyamide resin as the first base resin. The fluorescent pigment preferably contains at least one resin selected from the group consisting of a benzoguanamine resin, an acrylic resin and a polyester resin as the second base resin. The resin composition for forming the cover preferably further contains a fatty acid metal salt.

According to the present invention, a golf ball comprising a cover that contains a fluorescent pigment and is excellent in color development over a long period of time is obtained.

### BRIEF DESCRIPTION OF THE DRAWINGS

The FIGURE is a partially cutaway cross-sectional view of a golf ball of one embodiment according to the present invention.

### DESCRIPTION OF THE PREFERRED EMBODIMENT

The present invention provides a golf ball comprising a core and a cover covering the core, wherein the cover is formed from a resin composition containing a first base resin and a fluorescent pigment, the fluorescent pigment is a dispersion having a fluorescent dye dispersed in a second base resin, and an absolute value (|SP1-SP2|) of a difference between a solubility parameter value (SP1) ((cal/cm³)^{0.5}) of the first base resin and a solubility parameter value (SP2) ((cal/cm³)^{0.5}) of the second base resin is 6 or less. If the absolute value (|SP1-SP2|) of the difference is 6 or less, the fixation of the fluorescent pigment to the base resin of the cover is good and thus the color development over a long period of time improves.

The absolute value (|SP1-SP2|) of the difference between the solubility parameter value (SP1) ((cal/cm³)^{0.5}) of the first base resin and the solubility parameter value (SP2) ((cal/cm³)^{0.5}) of the second base resin is more preferably 3 or less, even more preferably 1 or less, particularly preferably 0.5 or less, and most preferably 0.3 or less.

The solubility parameter value (SP value) is δt defined by the following mathematical formula.

$$δ d = \frac{\sum {F}_{di}}{V} , \\ δ p = \frac{\sqrt{\sum {F}_{pi}^{2}}}{V} , \\ δ h = \sqrt{\frac{\sum {E}_{hi}}{V}} \\ {δ}_{t}^{2} = {δ}_{d}^{2} + {δ}_{p}^{2} + {δ}_{h}^{2} \qquad [ Mathematical formula 1 ]$$

In the mathematical formula, V is a volume V (cm³/mol) according to Fedors, and Fdi, Fpi and Ehi are solubility parameter components according to the method of Hoftyzer and Van Krevelen. Herein, δd is a London dispersion force, δp is a polar force, and δh is a hydrogen bonding force. The detailed method for calculating the SP value is described in Chapter 7, Properties of Polymers (D. W. VANKREVELEN, Publisher: ELSEVIER, Published year: Third impression 2003). Fdi, Fpi, Ehi and V of main functional groups are shown in Table 1.

TABLE 1

| Type of atomic | Fdi | Fpi | Ehi | V |
|---|---|---|---|---|
| group | J^{1/2}cm^{3/2}mol⁻¹ | J^{1/2}cm^{3/2}mol⁻¹ | J/mol | cm³/mol |
| —CH₃ | 420 | 0 | 0 | 33.5 |
| —CH₂— | 270 | 0 | 0 | 16.1 |
| 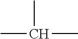 | 80 | 0 | 0 | −1.0 |
| 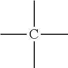 | −70 | 0 | 0 | −19.2 |
| ═CH₂ | 400 | 0 | 0 | 28.5 |
| ═CH— | 200 | 0 | 0 | 13.5 |
| ═C< | 70 | 0 | 0 | −5.5 |
| Phenyl | 1430 | 110 | 0 | 71.4 |
| Phenylene (o, m, | 1270 | 110 | 0 | 52.4 |
| p) | | | | |
| —F | (220) | — | — | 18.0 |
| —Cl | 450 | 550 | 400 | 24.0 |
| —Br | (550) | — | — | 30.0 |
| —CN | 430 | 1100 | 2500 | 24.0 |
| —OH | 210 | 500 | 20000 | 10.0 |
| —O— | 100 | 400 | 3000 | 3.8 |
| —COH (aldehyde) | 470 | 800 | 4500 | 22.3 |
| —CO— | 290 | 770 | 2000 | 10.8 |
| —COOH | 530 | 420 | 10000 | 28.5 |
| —COO— | 390 | 490 | 7000 | 18.0 |
| HCOO—(formate) | 530 | — | — | 32.5 |
| —NH₂ | 280 | — | 8400 | 19.2 |
| —NH— | 160 | 210 | 3100 | 4.5 |
| —N< | 20 | 800 | 5000 | −9.0 |
| —NO₂ | 500 | 1070 | 1500 | 24.0 |
| | | | | (aliphatic) |
| —S— | 440 | — | — | 12 |
| ═PO₄— | 740 | 1890 | 13000 | 28.0 |

### [Cover Resin Composition]

The cover resin composition contains a first base resin and a fluorescent pigment.

### (First Base Resin)

The first base resin is not particularly limited, and a conventional resin used for a cover of a golf ball may be used. The solubility parameter value (SP1) ((cal/cm³)^{0.5}) of the first base resin is preferably 9 or more, more preferably 9.5 or more, and even more preferably 9.8 or more, and is preferably 11 or less, more preferably 10.5 or less, and even more preferably 10.2 or less.

Examples of the first base resin include a polyurethane resin, an ionomer resin, and a polyamide resin. The cover resin composition preferably contains at least one resin selected from the group consisting of the polyurethane resin, the ionomer resin and the polyamide resin as the first base resin. The first base resin may be used solely, or at least two of them may be used in combination. In case of using two or more resins in combination as the first base resin, the SP value of the first base resin can be calculated from the SP value and volume ratio of each base resin. For example, in case of using two of the base resins in combination, if [volume ratio, London dispersion force, polar force, hydrogen bonding force] of the two base resins are adopted as [a, δd1, δp1, δh1] and [b, 0δd2, δp2, δh2], respectively, the London dispersion force (δdm), polar force (δpm) and hydrogen bonding force (δhm) of the resultant mixture are calculated according to the following mathematical formula.

$$δ dm = \frac{( a \times δ d 1 ) + ( b \times δ d 2 )}{a + b} \\ δ pm = \frac{( a \times δ p 1 ) + ( b \times δ p 2 )}{a + b} \\ δ hm = \frac{( a \times δ h 1 ) + ( b \times δ h 2 )}{a + b} \qquad [ Mathematical formula 2 ]$$

### (Polyurethane Resin)

The polyurethane resin is not particularly limited, as long as it has a plurality of urethane bonds in the molecule and shows thermoplasticity. Examples of the polyurethane resin include a product having urethane bonds formed in the molecule by a reaction between a polyisocyanate and a high molecular weight polyol, and where necessary, further by a chain extension reaction with a chain extender such as a low molecular weight polyol or a low molecular weight polyamine. As the polyurethane resin, a thermoplastic polyurethane is preferred.

The polyisocyanate component constituting the polyurethane resin is not particularly limited, as long as it has two or more isocyanate groups. Examples of the polyisocyanate component include an aromatic diisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), and para-phenylene diisocyanate (PPDI); and an alicyclic diisocyanate or aliphatic diisocyanate such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI). The above polyisocyanate component may be used solely or as a mixture of at least two of them.

From the viewpoint of enhancing abrasion resistance, the polyisocyanate component constituting the polyurethane resin is preferably an aromatic polyisocyanate. If the aromatic polyisocyanate is used, the obtained polyurethane resin has enhanced mechanical properties, and thus a cover excellent in abrasion resistance is obtained. Further, from the viewpoint of enhancing weather resistance, the polyisocyanate component constituting the polyurethane resin is preferably a non-yellowing polyisocyanate (such as TMXDI, XDI, HDI, H₆XDI, IPDI, H₁₂MDI, and NBDI), and 4,4′-dicyclohexylmethane diisocyanate (H₁₂MDI) is more preferable. This is because 4,4′-dicyclohexylmethane diisocyanate (H₁₂MDI) has a rigid structure, the obtained polyurethane resin has enhanced mechanical properties, and the obtained cover is excellent in abrasion resistance.

The polyol component constituting the polyurethane resin is not particularly limited, as long as it has a plurality of hydroxyl groups. Examples of the polyol component include a low molecular weight polyol and a high molecular weight polyol. Examples of the low molecular weight polyol include a diol such as ethylene glycol, diethylene glycol, triethylene glycol, propanediol (e.g. 1,2-propanediol, 1,3-propanediol, 2-methyl-1,3-propanediol and so on), dipropylene glycol, butanediol (e.g. 1,2-butanediol, 1,3-butanediol, 1,4-butanediol, 2,3-butanediol, 2,3-dimethyl-2,3-butanediol and so on), neopentyl glycol, pentanediol, hexanediol, heptanediol, octanediol, 1,6-cyclohexanedimethylol, aniline based diol, and bisphenol A based diol; a triol such as glycerin, trimethylolpropane, and hexanetriol; and a tetraol or hexaol such as pentaerythritol and sorbitol.

Examples of the high molecular weight polyol include a polyether polyol such as polyoxyethylene glycol (PEG), polyoxypropylene glycol (PPG), and polyoxytetramethylene glycol (PTMG); a condensed polyester polyol such as polyethylene adipate (PEA), polybutylene adipate (PBA), and polyhexamethylene adipate (PHMA); a lactone polyester polyol such as poly-ε-caprolactone (PCL); a polycarbonate polyol such as polyhexamethylene carbonate; and an acrylic polyol. The polyol may be used solely or as a mixture of at least two of them.

The number average molecular weight of the high molecular weight polyol is preferably 400 or more, and more preferably 1,000 or more, without any limitation. If the number average molecular weight of the high molecular weight polyol is 400 or more, the obtained polyurethane resin is not too hard and thus the golf ball has enhanced shot feeling. In addition, the number average molecular weight of the high molecular weight polyol is preferably 10,000 or less, and more preferably 8,000 or less, without any limitation. It is noted that the number average molecular weight of the polyol component can be measured, for example, by gel permeation chromatography (GPC), using polystyrene as a standard material, tetrahydrofuran as an eluate, and two columns of TSK-GEL SUPERH2500 (available from Tosoh Corporation) as a column.

In addition, the polyamine constituting the polyurethane resin, which is used where necessary, is not particularly limited, as long as it has at least two amino groups. Examples of the polyamine include an aliphatic polyamine such as ethylene diamine, propylene diamine, butylene diamine and hexamethylene diamine; an alicyclic polyamine such as isophorone diamine and piperazine; and an aromatic polyamine.

The aromatic polyamine is not particularly limited, as long as it has at least two amino groups directly or indirectly bonded to an aromatic ring. Herein, “indirectly bonded to an aromatic ring” means that the amino group is bonded to an aromatic ring, for example, via a lower alkylene group. The aromatic polyamine may be, for example, a monocyclic aromatic polyamine having at least two amino groups bonded to one aromatic ring, or a polycyclic aromatic polyamine having at least two aminophenyl groups which have at least one amino group bonded to one aromatic ring.

Examples of the monocyclic aromatic polyamine include a type having amino groups directly bonded to an aromatic ring, such as phenylene diamine, toluene diamine, diethyltoluene diamine and dimethylthiotoluene diamine; and a type having amino groups bonded to an aromatic ring via a lower alkylene group, such as xylyene diamine. In addition, the polycyclic aromatic polyamine may be a poly(aminobenzene) having at least two aminophenyl groups directly bonded to each other, or a polyamine having at least two aminophenyl groups bonded to each other via a lower alkylene group or an alkylene oxide group. Among them, a diaminodiphenyl alkane having two aminophenyl groups bonded to each other via a lower alkylene group is preferable, and 4,4′-diaminodiphenylmethane and a derivative thereof are particularly preferable.

Examples of the polyurethane resin include, but are not limited to, a polyurethane resin composed of a polyisocyanate component and a high molecular weight polyol component; a polyurethane resin composed of a polyisocyanate component, a high molecular weight polyol component and a low molecular weight polyol component; a polyurethane resin composed of a polyisocyanate component, a high molecular weight polyol component, a low molecular weight polyol component and a polyamine component; and a polyurethane resin composed of a polyisocyanate component, a high molecular weight polyol component and a polyamine component.

The slab hardness of the polyurethane resin is preferably 20 or more, more preferably 26 or more in Shore D hardness, and is preferably 55 or less, more preferably 52 or less, and even more preferably 49 or less in Shore D hardness. If the slab hardness of the polyurethane resin is 20 or more in Shore D hardness, the cover composition is not too soft and thus the resilience performance becomes better. In addition, if the slab hardness of the polyurethane resin is 55 or less in Shore D hardness, the cover composition is not too hard and thus the durability becomes better. Specific examples of the polyurethane resin include “Elastollan (registered trademark) 1195ATR, ET880, 1198ATR, 1154D, NY82A” available from BASF Japan Ltd.

### (Ionomer Resin)

Examples of the ionomer resin include an ionomer resin consisting of a metal ion-neutralized product of a binary copolymer composed of an olefin and an α,β-unsaturated carboxylic acid having 3 to 8 carbon atoms (hereinafter, sometimes simply referred to as “a binary ionomer resin”); an ionomer resin consisting of a metal ion-neutralized product of a ternary copolymer composed of an olefin, an α,β-unsaturated carboxylic acid having 3 to 8 carbon atoms and an α,β-unsaturated carboxylic acid ester (hereinafter, sometimes simply referred to as “a ternary ionomer resin”); and a mixture thereof.

The olefin is preferably an olefin having 2 to 8 carbon atoms. Examples of the olefin include ethylene, propylene, butene, pentene, hexene, heptene and octene, and ethylene is particularly preferred. Examples of the α,β-unsaturated carboxylic acid having 3 to 8 carbon atoms include acrylic acid, methacrylic acid, fumaric acid, maleic acid and crotonic acid, and acrylic acid or methacrylic acid is particularly preferred.

As the α,β-unsaturated carboxylic acid ester, an alkyl ester of an α,β-unsaturated carboxylic acid having 3 to 8 carbon atoms is preferable, an alkyl ester of acrylic acid, methacrylic acid, fumaric acid or maleic acid is more preferable, and an alkyl ester of acrylic acid or an alkyl ester of methacrylic acid is particularly preferable. Examples of the alkyl constituting the alkyl ester include methyl, ethyl, propyl, n-butyl, and isobutyl.

As the binary ionomer resin, a metal ion-neutralized product of an ethylene-(meth)acrylic acid binary copolymer is preferable. As the ternary ionomer resin, a metal ion-neutralized product of a ternary copolymer composed of ethylene, (meth)acrylic acid and (meth)acrylic acid ester is preferable. Herein, (meth)acrylic acid means acrylic acid and/or methacrylic acid.

The amount of the α,β-unsaturated carboxylic acid component having 3 to 8 carbon atoms in the binary copolymer constituting the binary ionomer resin and the ternary copolymer constituting the ternary ionomer resin is preferably 4 mass % or more, more preferably 6 mass % or more, and even more preferably 8 mass % or more, and is preferably 50 mass % or less, more preferably 30 mass % or less, even more preferably 20 mass % or less, and most preferably 15 mass % or less. If the amount of the α,β-unsaturated carboxylic acid component having 3 to 8 carbon atoms is 4 mass % or more, the binary ionomer resin and the ternary ionomer resin have higher rebound resilience, and if the amount of the α,β-unsaturated carboxylic acid component having 3 to 8 carbon atoms is 50 mass % or less, the binary ionomer resin and the ternary ionomer resin have enhanced flexibility.

Examples of the metal ion for neutralizing at least a part of carboxyl groups of the binary ionomer resin and/or the ternary ionomer resin include monovalent metal ions such as sodium, potassium, lithium and the like; divalent metals ions such as magnesium, calcium, zinc, barium, cadmium and the like; trivalent metals ions such as aluminum and the like; and other ions such as tin, zirconium and the like. The binary ionomer resin and the ternary ionomer resin preferably are neutralized with at least one metal ion selected from the group consisting of Na⁺, Mg²⁺, Ca²⁺ and Zn²⁺

The neutralization degree of the carboxyl groups of the binary ionomer resin and the ternary ionomer resin is preferably 15 mole % or more, more preferably 20 mole % or more, and even more preferably 50 mole % or more, and is preferably 100 mole % or less, more preferably 85 mole % or less. If the neutralization degree is 15 mole % or more, the obtained golf ball has better resilience and durability, and if the neutralization degree is 100 mole % or less, the golf ball resin composition has better fluidity (better moldability). It is noted that the neutralization degree of the carboxyl groups of the ionomer resin may be calculated by the following expression.

Neutralization degree of ionomer resin (mole %)=100×(mole number of neutralized carboxyl groups in copolymer/mole number of all carboxyl groups in copolymer)

As the binary ionomer resin and the ternary ionomer resin, an ionomer resin which has been neutralized in advance may be used, or a blend of a metal compound with a binary copolymer composed of an olefin and an α,β-unsaturated carboxylic acid having 3 to 8 carbon atoms and/or a ternary copolymer composed of an olefin, an α,β-unsaturated carboxylic acid having 3 to 8 carbon atoms and an α,β-unsaturated carboxylic acid ester may be used. The binary ionomer resin and the ternary ionomer resin may be used solely, or at least two of them may be used in combination.

The metal compound is not particularly limited, as long as it can neutralize carboxyl groups. Examples of the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate.

Examples of the binary ionomer resin include Himilan (registered trademark) 1555 (Na), 1557 (Zn), 1605 (Na), 1706 (Zn), 1707 (Na), AM7311 (Mg), AM7329 (Zn) (available from Mitsui-Du Pont Polychemicals Co., Ltd.); Surlyn (registered trademark) 8945 (Na), 9945 (Zn), 8140 (Na), 8150 (Na), 9120 (Zn), 9150 (Zn), 6910 (Mg), 6120 (Mg), 7930 (Li), 7940 (Li), AD8546 (Li) (available from E.I. du Pont de Nemours and Company); and lotek (registered trademark) 8000 (Na), 8030 (Na), 7010 (Zn), 7030 (Zn) (available from ExxonMobil Chemical Corporation).

Examples of the ternary ionomer resin include Himilan AM7327 (Zn), 1855 (Zn), 1856 (Na), AM7331 (Na) (available from Mitsui-Du Pont Polychemicals Co., Ltd.); Surlyn 6320 (Mg), 8120 (Na), 8320 (Na), 9320 (Zn), 9320W (Zn), HPF 1000 (Mg), HPF 2000 (Mg) (available from E.I. du Pont de Nemours and Company); and lotek 7510 (Zn), 7520 (Zn) (available from ExxonMobil Chemical Corporation).

Examples of the binary copolymer include Nucrel (registered trademark) N1050H, N2050H, N1110H, NO200H (available from Mitsui-Du Pont Polychemicals Co., Ltd.); and Primacor (registered trademark) 59801 (available from Dow Chemical Company). Examples of the ternary copolymer include Nucrel AN4318, AN4319 (available from Mitsui-Du Pont Polychemicals Co., Ltd.); and Primacor (registered trademark) AT310, AT320 (available from Dow Chemical Company). It is noted that Na, Zn, Li, Mg and the like described in the parentheses after the trade names indicate metal types of neutralizing metal ions of the ionomer resins.

### (Fluorescent Pigment)

The fluorescent pigment is a dispersion having a fluorescent dye dispersed in a second base resin. The fluorescent pigment preferably has the fluorescent dye dispersed and fixed in the second base resin. Examples of the fluorescent pigment having the fluorescent dye fixed in the second base resin include a fluorescent pigment having the fluorescent dye fixed in a thermosetting resin which is used as the second base resin; and a fluorescent pigment obtained by reacting the fluorescent dye with a base resin to fix the fluorescent dye in the base resin.

### Second Base Resin

The second base resin is not particularly limited, and a conventional resin used for a fluorescent pigment may be used. The solubility parameter value (SP2) ((cal/cm³)^{0.5}) of the second base resin is preferably 6 or more, more preferably 8 or more, and even more preferably 9 or more, and is preferably 16 or less, more preferably 13 or less, and even more preferably 11 or less.

Examples of the second base resin include a benzoguanamine resin, an acrylic resin, and a polyester resin. The fluorescent pigment preferably contains at least one resin selected from the group consisting of the benzoguanamine resin, the acrylic resin and the polyester resin as the second base resin. The second base resin may be used solely, or at least two of them may be used in combination. In case of using two or more resins in combination as the second base resin, the SP value of the second base resin can be calculated from the SP value and volume ratio of each base resin, similarly to that of the first base resin.

### Benzoguanamine Resin

Examples of the benzoguanamine resin include a condensation product of benzoguanamine and formaldehyde.

### Acrylic Resin

Examples of the acrylic resin include a polymer of acrylic acid ester and a polymer of methacrylic acid ester. Examples of the polymer of acrylic acid ester include polyacrylic acid methyl ester, polyacrylic acid ethyl ester, and polyacrylic acid butyl ester. Examples of the polymer of methacrylic acid ester include polymethacrylic acid methyl ester, polymethacrylic acid ethyl ester, and polymethacrylic acid butyl ester.

### Polyester Resin

The polyester resin is not particularly limited, as long as it has a plurality of ester bonds in the main chain of the molecule thereof. As the polyester resin, a polyester resin obtained by a reaction between a dicarboxylic acid and a diol is preferable.

### Fluorescent Dye

The fluorescent dye may be either an organic fluorescent dye or an inorganic fluorescent dye, and may be any one of commercially available fluorescent dyes. Examples of the fluorescent dye include a thioxanthene derivative, a xanthene derivative, a perylene derivative, a peryleneimide derivative, a coumarin derivative, a thioindigo derivative, a naphthalimide derivative and a methine derivative.

Specific examples of the fluorescent dye include, but are not limited to, yellow fluorescent dyes such as trade names of Lumogen F Orange™ 240 (available from BASF Ltd.); Lumogen F Yellow™ 083 (available from BASF Ltd.); Hostasol Yellow™ 3G (available from Hoechst-Celanese Corp.); Oraset Yellow™ 8GF (available from Ciba-Geigy Corp.); Fluorol 088™ (available from BASF Ltd.); Thermoplast F Yellow™ 084 (available from BASF Ltd.); Golden Yellow™ D-304 (available from DayGlo Color Corp.); Mohawk Yellow™ D-299 (available from DayGlo Color Corp.); Potomac Yellow™ D-838 (available from DayGlo Color Corp.); and Polyfast Brilliant Red™ SB (available from Keystone Corp.).

The amount of the fluorescent pigment is preferably 1 part by mass or more, more preferably 2 parts by mass or more, and is preferably 10 parts by mass or less, more preferably 7 parts by mass or less, and even more preferably 5 parts by mass or less, with respect to 100 parts by mass of the first base resin.

### (Ultraviolet Absorber and Light Stabilizer)

The above-described fluorescent pigment has a low light stability, so the cover resin composition preferably contains an ultraviolet absorber or a light stabilizer. The ultraviolet absorber or the light stabilizer is not particularly limited, and any commercially available product may be used. Examples of the ultraviolet absorber include a salicylic acid derivative, a benzophenone derivative, a benzotriazole derivative, a cyanoacrylate derivative, a triazine derivative, and a nickel complex. Examples of the light stabilizer include a hindered amine derivative.

Examples of the salicylic acid derivative ultraviolet absorber include phenyl salicylate, p-t-butylphenyl salicylate, and p-octylphenyl salicylate; examples of the benzophenone derivative ultraviolet absorber include 2,4-dihydroxylbenzophenone, 2-hydroxyl-4-methoxybenzophenone, 2-hydroxyl-4-octyloxybenzophenone, and 2,2-dihydroxyl-4,4′-methoxybenzophenone; examples of the benzotriazole derivative ultraviolet absorber include 2-(2′-hydroxyl-5-methylphenyl) benzotriazole, 2-(2′-hydroxyl-5′-t-butylphenyl) benzotriazole, 2-(2′-hydroxyl-3′-t-butyl-5′-methylphenyl)-5-chlorobenzotriazole, 2-[2-hydroxyl-3,5-bis(α,α′-dimethylbenzyl)phenyl]-2H-benzotriazole, and 2-(5-methyl-2-hydroxylphenyl) benzotriazole; examples of the cyanoacrylate derivative ultraviolet absorber include 2-ethylhexyl-2-cyano-3,3′-diphenyl acrylate, and ethyl-2-cyano-3,3′-diphenyl acrylate; and examples of the triazine derivative ultraviolet absorber include 2-(4,6-diphenyl-1,3,5-triazine-2-yl)-5[(hexyl)oxy]-phenol, 2,4-bis(2-hydroxyl-4-butoxyphenyl)-6-(2,4-bis-butoxyphenyl)-1,3,5-triazine, and 2-(4-{[2-hydroxyl-3-(2′-ethyl)hexyl]oxy}-2-hydroxylphenyl)-4,6-bis(2,4-dimethylphenyl)-1,3,5-triazine. Specific examples include “Sumisorb 130” and “Sumisorb 140” (both of which are benzophenone ultraviolet absorber) available from Sumitomo Chemical Co., Ltd.; “TINUVIN 234”, “TINUVIN 900”, “TINUVIN 326” and “TINUVIN P” (all of which are benzotriazole ultraviolet absorber) available from Chiba Specialty Chemicals Co., Ltd.; “Uvinul N-35” (which is cyanoacrylate ultraviolet absorber) available from BASF Ltd.; and “TINUVIN 1577”, “TINUVIN 460” and “TINUVIN 405” (all of which are triazine ultraviolet absorber) available from Chiba Specialty Chemicals Co., Ltd. These ultraviolet absorbers may be used solely, or at least two of them may be used in combination. It is noted that the ultraviolet absorber which can be used in the present invention is not limited to the above ultraviolet absorbers, any one of conventional ultraviolet absorbers can be used.

Examples of the hindered amine derivative light stabilizer include bis(1,2,2,6,6-pentamethyl-4-piperidyl) {[3,5-bis(1,1′-dimethylethyl)-4-hydroxylphenyl]methyl}butyl malonate, 1-{2-[3-(3,5-di-t-butyl-4-hydroxylphenyl) propionyloxy]ethyl}-4-[3-(3,5-di-t-butyl-4-hydroxylphenyl)propionyloxy]-2,2,6,6-tetramethylpiperidine, and bis(2,2,6,6-tetramethyl-4-piperidyl) sebacate. Specific examples include “Sanol LS-2626” and “TINUVIN 144” available from Chiba Specialty Chemicals Co., Ltd.; and “JF-90” available from Johoku Chemical Co. Ltd.

### (Fatty Acid Metal Salt)

The resin composition preferably further contains a fatty acid metal salt. If the fatty acid metal salt is contained, the color development is stabilized. It is considered that this is because if the fatty acid metal salt is contained, a new intermolecular interaction between the first base resin and the fluorescent pigment is generated such that the strength keeping the fluorescent pigment in the cover becomes greater.

The fatty acid metal salt is not particularly limited, as long as it is a metal salt of an aliphatic carboxylic acid. The fatty acid metal salt may be a metal salt of a saturated fatty acid or a metal salt of an unsaturated fatty acid. In addition, the fatty acid constituting the fatty acid metal salt may further have a functional group such a hydroxyl group. The fatty acid metal salt may be used solely, or at least two of them may be used in combination.

The number of carbon atoms of the fatty acid constituting the fatty acid metal salt is preferably 12 or more and 30 or less. If the number of carbon atoms of the fatty acid is 12 or more and 30 or less, the intermolecular interaction between the first base resin and the fluorescent pigment is easily generated.

Specific examples of the saturated fatty acid (IUPAC name) include dodecanoic acid (C12), tridecanoic acid (C13), tetradecanoic acid (C14), pentadecanoic acid (C15), hexadecanoic acid (C16), heptadecanoic acid (C17), octadecanoic acid (C18), nonadecanoic acid (C19), icosanoic acid (C20), henicosanoic acid (C21), docosanoic acid (C22), tricosanoic acid (C23), tetracosanoic acid (C24), pentacosanoic acid (C25), hexacosanoic acid (C26), heptacosanoic acid (C27), octacosanoic acid (C28), nonacosanoic acid (C29), and triacontanoic acid (C30).

Specific examples of the saturated fatty acid (Common name) include lauric acid (C12), myristic acid (C14), pentadecylic acid (C15), palmitic acid (C16), margaric acid (C17), stearic acid (C18), arachidic acid (C20), behenic acid (C22), lignoceric acid (C24), cerotic acid (C26), montanic acid (C28), and melissic acid (C30).

Specific examples of the unsaturated fatty acid (IUPAC name) include dodecenoic acid (C12), tridecenoic acid (C13), tetradecenoic acid (C14), pentadecenoic acid (C15), hexadecenoic acid (C16), heptadecenoic acid (C17), octadecenoic acid (C18), nonadecenoic acid (C19), icosenoic acid (C20), henicosenoic acid (C21), docosenoic acid (C22), tricosenoic acid (C23), tetracosenoic acid (C24), pentacosenoic acid (C25), hexacosenoic acid (C26), heptacosenoic acid (C27), octacosenoic acid (C28), nonacosenoic acid (C29), and triacontenoic acid (C30).

Specific examples of the unsaturated fatty acid (Common name) include myristoleic acid (C14), palmitoleic acid (C16), stearidonic acid (C18), elaidic acid (C18), vaccenic acid (C18), oleic acid (C18), linoleic acid (C18), linolenic acid (C18), elaidic acid (C18), gadoleic acid (C20), arachidonic acid (C20), eicosenoic acid (C20), eicosapentaenoic acid (C20), eicosadienoic acid (C20), docosahexaenoic acid (C22), erucic acid (C22), and nervonic acid (C24).

Examples of the fatty acid having a hydroxyl group include ricinoleic acid, hydroxyllauric acid (e.g. 10-hydroxyllauric acid, 12-hydroxyllauric acid), hydroxylmyristic acid (e.g. 2-hydroxylmyristic acid, 3-hydroxylmyristic acid), hydroxylpalmitic acid (e.g. 2-hydroxylpalmitic acid), and hydroxylstearic acid (e.g. 12-hydroxylstearic acid).

Preferable examples of the fatty acid constituting the fatty acid metal salt include lauric acid, ricinoleic acid, and hydroxylstearic acid.

Examples of the metal component constituting the fatty acid metal salt include a monovalent metal ion such as sodium, potassium, lithium or the like; a divalent metal ion such as magnesium, calcium, zinc, barium, cadmium or the like; a trivalent metal ion such as aluminum or the like; and other metal ions such as tin, zirconium or the like. The metal component may be used solely or as a mixture of at least two of them. Among them, the divalent metal such as barium and zinc are preferable as the metal component.

The amount of the fatty acid metal salt is preferably 0.01 part by mass or more, more preferably 0.1 part by mass or more, and even more preferably 0.25 part by mass or more, and is preferably 1 part by mass or less, more preferably 0.75 part by mass or less, and even more preferably 0.5 part by mass or less, with respect to 100 parts by mass of the first base resin. If the amount of the fatty acid metal salt is 0.01 part by mass or more, the new intermolecular interaction between the first base resin and the fluorescent pigment is easily generated and thus the color development stability is further enhanced, and if the amount of the fatty acid metal salt is 1 part by mass or less, occurrence of poor dispersion is suppressed and thus the intermolecular interaction is effectively exerted.

The mass ratio of the fatty acid metal salt to the fluorescent pigment in the resin composition (fatty acid metal salt/fluorescent pigment) is preferably 0.01 or more, more preferably 0.03 or more, and even more preferably 0.05 or more, and is preferably 0.20 or less, more preferably 0.14 or less, and even more preferably 0.08 or less. If the mass ratio is 0.01 or more and 0.20 or less, the new intermolecular interaction between the first base resin and the fluorescent pigment is easily generated and thus the color development stability is further enhanced.

When the resin composition contains the fatty acid metal salt, it is preferred that the first base resin is the polyurethane resin and the second base resin is the benzoguanamine resin. This is because the hydrocarbon chain of the fatty acid metal salt interacts with the benzene ring portion of the benzoguanamine resin and the carboxylate group of the fatty acid metal salt interacts with the urethane group of the polyurethane resin such that the strength of keeping the fluorescent pigment in the cover becomes greater.

### (Titanium Oxide)

Although the cover containing the fluorescent pigment is preferably transparent or translucent, the cover may contain titanium oxide. If the fluorescent pigment is combined with a small amount of titanium oxide, a translucent cover having a vivid color is obtained. Titanium oxide has high opacity, and thus the amount of titanium oxide is preferably 0.001 part by mass or more, more preferably 0.002 part by mass or more, and even more preferably 0.005 part by mass or more, and is preferably less than 0.5 part by mass, more preferably 0.45 part by mass or less, and even more preferably 0.3 part by mass or less, with respect to 100 parts by mass of the resin component. If the amount of titanium oxide is 0.001 part by mass or more, a translucent cover having a vivid color is obtained, and if the amount of titanium oxide is 0.5 part by mass or more, the cover tends to show opacity.

### (Other Component)

In addition to the above-described components, the resin composition may further contain a pigment component, a mass adjusting agent such as zinc oxide, calcium carbonate, barium sulfate or the like, a dispersant, an antioxidant, a fluorescent brightener, a lubricant, or a light stabilizer, unless they impair the function of the cover.

The cover resin composition can be obtained, for example, by dry blending the first base resin, the fluorescent pigment, and additives which are added where necessary. Further, the dry blended mixture may be extruded into a pellet form. Dry blending is preferably carried out by using, for example, a mixer capable of blending raw materials in a pellet form, and more preferably carried out by using a tumbler type mixer. Extruding can be carried out by using a conventional extruder such as a single-screw extruder, a twin-screw extruder, and a twin-single extrude

### [Golf Ball]

The construction of the golf ball according to the present invention is not particularly limited, as long as the golf ball comprises a spherical core and a cover covering the spherical core. Examples of the construction of the golf ball include a two-piece golf ball comprising a single-layered spherical core and a cover covering the spherical core; a three-piece golf ball comprising a spherical core consisting of a center and one intermediate layer covering the center, and a cover covering the spherical core; a multi-piece golf ball comprising a spherical core consisting of a center and at least two intermediate layers covering the center, and a cover covering the spherical core; and the like.

The core or center may be formed by using a conventional rubber composition (hereinafter, sometimes simply referred to as “core rubber composition”). For example, the core or center may be formed by heat pressing a rubber composition containing a base rubber, a co-crosslinking agent, and a crosslinking initiator.

As the base rubber, particularly preferred is a high cis-polybutadiene having a cis-bond which is beneficial to the resilience in an amount of 40 mass % or more, preferably 70 mass % or more, and more preferably 90 mass % or more. As the co-crosslinking agent, an α,β-unsaturated carboxylic acid having 3 to 8 carbon atoms or a metal salt thereof is preferred, and an acrylic acid metal salt and a methacrylic acid metal salt are more preferred. As the metal constituting the metal salt, zinc, magnesium, calcium, aluminum and sodium are preferred, and zinc is more preferred. The amount of the co-crosslinking agent is preferably 20 parts by mass or more and 50 parts by mass or less with respect to 100 parts by mass of the base rubber. When the α,β-unsaturated carboxylic acid having 3 to 8 carbon atoms is used as the co-crosslinking agent, a metal compound (e.g. magnesium oxide) is preferably blended. As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane and di-t-butyl peroxide. Among them, dicumyl peroxide is preferably used. The amount of the crosslinking initiator is preferably 0.2 part by mass or more, more preferably 0.3 part by mass or more, and is preferably 5 parts by mass or less, more preferably 3 parts by mass or less, with respect to 100 parts by mass of the base rubber.

The core rubber composition may further contain an organic sulfur compound. Examples of the organic sulfur compound include diphenyl disulfides, thiophenols, and thionaphthols. The amount of the organic sulfur compound is preferably 0.1 part by mass or more, more preferably 0.3 part by mass or more, and is preferably 5.0 parts by mass or less, more preferably 3.0 parts by mass or less, with respect to 100 parts by mass of the base rubber. The core rubber composition may further contain a carboxylic acid and/or a salt thereof. As the carboxylic acid and/or the salt thereof, a carboxylic acid having 1 to 30 carbon atoms and/or a salt thereof is preferred. As the carboxylic acid, any one of an aliphatic carboxylic acid and an aromatic carboxylic acid (such as benzoic acid) may be used. The amount of the carboxylic acid and/or the salt thereof is 1 part by mass or more and 40 parts by mass or less with respect to 100 parts by mass of the base rubber.

The core rubber composition may further contain a weight adjusting agent such as zinc oxide and barium sulfate, an antioxidant, a colored powder, or the like appropriately, in addition to the base rubber, the co-crosslinking agent, the crosslinking initiator and the organic sulfur compound. Conditions for molding the core rubber composition by a heat pressing method may be set appropriately in accordance with the formulation of the core rubber composition. Generally, it is preferred that the core rubber composition is heated at 130° C. to 200° C. for 10 to 60 minutes, or alternatively the core rubber composition is subjected to a two-step heating, i.e. the core rubber composition is heated at 130° C. to 150° C. for 20 to 40 minutes and then heated at 160° C. to 180° C. for 5 to 15 minutes.

In the case that the spherical core has an intermediate layer, examples of the intermediate layer material include a thermoplastic resin such as a polyurethane resin, an ionomer resin, a polyamide resin, and polyethylene; a thermoplastic elastomer such as a styrene elastomer, a polyolefin elastomer, a polyurethane elastomer, a polyamide elastomer, and a polyester elastomer; and a cured product of a rubber composition. Herein, examples of the ionomer resin include a product prepared by neutralizing at least a part of carboxyl groups in a copolymer composed of ethylene and an α,β-unsaturated carboxylic acid with a metal ion; and a product prepared by neutralizing at least a part of carboxyl groups in a ternary copolymer composed of ethylene, an α,β-unsaturated carboxylic acid and an α,β-unsaturated carboxylic acid ester with a metal ion. The intermediate layer may further contain a weight adjusting agent such as barium sulfate and tungsten, an antioxidant, and a pigment.

Examples of the method for molding the intermediate layer include, but are not limited to, a method which comprises molding the intermediate layer composition into a hemispherical half shell beforehand, covering the spherical body with two of the half shells and performing the compression molding; and a method which comprises injection molding the intermediate layer composition directly onto the spherical body to cover the spherical body.

In the case of injection molding the intermediate layer composition onto the spherical body to form the intermediate layer, it is preferred to use upper and lower molds, each having a hemispherical cavity. When molding the intermediate layer by the injection molding method, the hold pin is protruded to hold the spherical body, and the intermediate layer composition which has been heated and melted is charged and then cooled to form the intermediate layer.

When molding the intermediate layer by the compression molding method, the molding of the half shell may be performed by either a compression molding method or an injection molding method, and the compression molding method is preferred. Compression molding the intermediate layer composition into the half shell may be carried out, for example, under a pressure of 1 MPa or more and 20 MPa or less at a molding temperature of −20° C. or more and +70° C. or less relative to the flow beginning temperature of the intermediate layer composition. If the molding is carried out under the above conditions, the half shell having a uniform thickness can be formed. Examples of the method for molding the intermediate layer by using the half shell include a method of covering the spherical body with two of the half shells and performing the compression molding. Compression molding the half shells into the intermediate layer may be carried out, for example, under a molding pressure of 0.5 MPa or more and 25 MPa or less at a molding temperature of −20° C. or more and +70° C. or less relative to the flow beginning temperature of the intermediate layer composition. If the molding is carried out under the above conditions, the intermediate layer having a uniform thickness can be formed.

It is noted that the molding temperature means the highest temperature where the temperature at the surface of the concave portion of the lower mold reaches from closing the mold to opening the mold. In addition, the flow beginning temperature of the thermoplastic resin composition may be measured using the thermoplastic resin composition in a pellet form under the following conditions with “Flow Tester CFT-500” available from Shimadzu Corporation.

Measuring conditions: Plunger area: 1 cm², Die length: 1 mm, Die diameter: 1 mm, Load: 588.399 N, Starting temperature: 30° C., and Temperature increase rate: 3° C./min.

The spherical core preferably has a diameter of 34.8 mm or more, more preferably 36.8 mm or more, and even more preferably 38.8 mm or more, and preferably has a diameter of 42.2 mm or less, more preferably 41.8 mm or less, even more preferably 41.2 mm or less, and most preferably 40.8 mm or less. If the spherical core has a diameter of 34.8 mm or more, the thickness of the cover does not become too thick and thus the resilience is better. On the other hand, if the spherical core has a diameter of 42.2 mm or less, the thickness of the cover does not become too thin and thus the cover functions better.

Examples of the method for molding the cover composition into the cover include, but are not limited to, a method which comprises injection molding the cover composition directly onto the spherical core; and a method which comprises molding the cover composition into a hollow shell, covering the spherical core with a plurality of the hollow shells and performing the compression molding (preferably a method which comprises molding the cover composition into a hollow half-shell, covering the spherical core with two of the half-shells and performing the compression molding). The golf ball body having the cover formed thereon is ejected from the mold, and is preferably subjected to surface treatments such as deburring, cleaning and sandblast where necessary. In addition, if desired, a paint film or a mark may be formed.

The thickness of the cover is preferably 0.3 mm or more, more preferably 0.4 mm or more, and even more preferably 0.5 mm or more, and is preferably 2.0 mm or less, more preferably 1.5 mm or less, and even more preferably 1.0 mm or less. If the thickness of the cover is 0.3 mm or more, molding the cover becomes easier, and if the thickness of the cover is 2.0 mm or less, the core has a relatively large diameter and thus the golf ball has enhanced resilience performance.

The total number of dimples formed on the cover is preferably 200 or more and 500 or less. If the total number of dimples is less than 200, the dimple effect is hardly obtained. On the other hand, if the total number of dimples exceeds 500, the dimple effect is hardly obtained because the size of the respective dimple is small. The shape (shape in a plan view) of dimples formed on the cover includes, without limitation, a circle; a polygonal shape such as a roughly triangular shape, a roughly quadrangular shape, a roughly pentagonal shape and a roughly hexagonal shape; and other irregular shape. These shapes may be employed solely, or at least two of them may be employed in combination.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is preferably, but not limited to, 5 μm or more, more preferably 7 μm or more, and is preferably 50 μm or less, more preferably 40 μm or less, and even more preferably 30 μm or less. If the thickness of the paint film is less than 5 μm, the paint film is easy to wear off due to the continued use of the golf ball, and if the thickness of the paint film exceeds 50 μm, the dimple effect is reduced and thus the flight performance of the golf ball may be lowered.

The golf ball according to the present invention preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, particularly preferably 42.80 mm or less. In addition, the golf ball according to the present invention preferably has a mass of 40 g or more and 50 g or less. In light of obtaining greater inertia, the mass is more preferably 44 g or more, particularly preferably 45.00 g or more. In light of satisfying the regulation of USGA, the mass is particularly preferably 45.93 g or less.

The FIGURE is a partially cutaway view of a golf ball 1 according to one embodiment of the present invention. The golf ball 1 comprises a spherical core 2, and a cover 3 covering the spherical core 2. A plurality of dimples 31 are formed on the surface of the cover. Other portions than the dimples 31 on the surface of the golf ball 1 are land 32. The golf ball 1 is provided with a paint layer and a mark layer outside the cover 3, but these layers are not depicted.

### EXAMPLES

Next, the present invention will be described in detail by way of examples. However, the present invention is not limited to the examples described below. Various changes and modifications without departing from the spirit of the present invention are included in the scope of the present invention.

### [Measuring Conditions]

### (1) Color Tone

Color tone of the cover was measured with a color-difference meter (“CM-3500d” available from Konica Minolta, Inc). It is noted that the color tone of the cover was measured in a state of the golf ball body having the cover formed on the core.

### (2) Color Development Stability

The golf ball immediately after molding and the golf ball one month later after molding were compared and evaluated by a plurality of people. The evaluation was ranked as follows in accordance with the number of people who answered that there was no change in the color development. It is noted that the color development was evaluated based on JIS 5600-4-3 (1999).
1: 80% or more
2: 60% or more and less than 80%
3: 40% or more and less than 60%
4: 20% or more and less than 40%
5: less than 20%

### [Production of Golf Ball]

### (1) Production of Core

The rubber composition having the formulation shown in Table 2 was kneaded with a kneading roll and heat pressed in upper and lower molds, each having a hemispherical cavity, at 170° C. for 20 minutes to produce spherical cores having a diameter of 39.5 mm.

TABLE 2
Core rubber composition

| | | |
|---|---|---|
| Formulation | Polybutadiene rubber | 100 |
| (parts by mass) | Zinc acrylate | 25 |
| | Zinc oxide | 4 |
| | Titanium oxide | 2 |
| | Diphenyldisulfide | 0.6 |
| | Dicumyl peroxide | 0.6 |

The materials used in Table 2 are shown as follows.

Polybutadiene rubber: high-cis polybutadiene “BR-730” (cis-1,4 bond amount=96 mass %, 1,2-vinyl bond amount=1.3 mass %, Moony viscosity (ML₁₊₄ (100° C.)=55, molecular weight distribution (Mw/Mn)=3) available from JSR Corporation

Zinc acrylate: “ZNDA-90S” available from Nisshoku Techno Fine Chemical Co., Ltd.

Zinc oxide: “Ginrei R” available from Toho Zinc Co., Ltd.

Titanium oxide: “A220” available from Ishihara Sangyo Co., Ltd.

Diphenyldisulfide: available from Sumitomo Seika Chemicals Co., Ltd.

Dicumyl peroxide: “PERCUMYL (registered trademark) D” available from NOF Corporation

The materials having the formulations shown in Table 3 were dry blended, and mixed with a twin-screw kneading extruder to prepare the cover compositions in a pellet form. The extruding conditions were a screw diameter of 45 mm, a screw rotational speed of 200 rpm, and screw L/D=35, and the mixture was heated to 150° C. to 230° C. at the die position of the extruder. The thickness of the cover was set to 1.6 mm.

TABLE 3

| Golf ball No. | | | 1 | 2 | 3 | 4 | 5 | 6 | 7 |
|---|---|---|---|---|---|---|---|---|---|
| Formulation | Polyurethane resin | | 100 | 100 | 100 | 100 | 100 | 100 | 100 |
| (parts by mass) | Wax Master VD | | 1.7 | 1.7 | 1.7 | 1.7 | 1.7 | 1.7 | 1.7 |
| | JF-90 | | 0.2 | 0.2 | 0.2 | 0.2 | 0.2 | 0.2 | 0.2 |
| | Titanium oxide | | 0.05 | 0.05 | 0.05 | 0.05 | 0.05 | 0.05 | 0.05 |
| | Fluorescent | EPO Color FP3000 | 3 | — | — | — | — | — | — |
| | pigment | Lumicolor Yellow | — | 4.5 | — | 4.5 | 4.5 | 4.5 | — |
| | | FX305 | — | — | 4.5 | — | — | — | 4.5 |
| | | ZQ17 | — | — | — | — | — | — | — |
| | Fatty acid | Barium ricinoleate | — | — | — | 0.25 | — | — | 0.25 |
| | metal salt | Zinc 12- | — | — | — | — | 0.25 | — | — |
| | | hydroxystearate | | | | | | | |
| | | Zinc laurate | — | — | — | — | — | 0.25 | — |
| SP value of first base resin of cover: SP1 ((cal/cm³)^{0.5}) | | | 10 | 10 | 10 | 10 | 10 | 10 | 10 |
| SP value of second base resin of fluorescent pigment: | | | 9.9 | 9.5 | 9.9 | 9.5 | 9.5 | 9.5 | 9.9 |
| SP2 ((cal/cm³)^{0.5}) | | | | | | | | | |
| Absolute value of difference between SP values: | | | 0.1 | 0.5 | 0.1 | 0.5 | 0.5 | 0.5 | 0.1 |
| (\| SP1 − SP2\|) | | | | | | | | | |
| Evaluation | Color tone | L* value | 93.2 | 86.06 | 99.72 | 83.31 | 83.31 | 90.44 | 95.08 |
| | | a* value | −36.9 | −44.2 | −40.8 | −41.6 | −41.6 | −35.5 | −44.2 |
| | | b* value | 83.39 | 79.9 | 117.7 | 69.77 | 69.48 | 54.3 | 109.7 |

| | | | | | | | |
|---|---|---|---|---|---|---|---|
| Color development stability | 1 | 3 | 2 | 2 | 2 | 2 | 1 |

| Golf ball No. | | | 8 | 9 | 10 | 11 | 12 | 13 |
|---|---|---|---|---|---|---|---|---|
| Formulation | Polyurethane resin | | 100 | 100 | 100 | 100 | 100 | 100 |
| (parts by mass) | Wax Master VD | | 1.7 | 1.7 | 1.7 | 1.7 | 1.7 | 1.7 |
| | JF-90 | | 0.2 | 0.2 | 0.2 | 0.2 | 0.2 | 0.2 |
| | Titanium oxide | | 0.05 | 0.05 | 0.05 | 0.05 | 0.05 | 0.05 |
| | Fluorescent | EPO Color FP3000 | — | — | — | — | — | — |
| | pigment | Lumicolor Yellow | — | — | — | — | — | — |
| | | FX305 | 4.5 | 4.5 | — | — | — | — |
| | | ZQ17 | — | — | 4.5 | 4.5 | 4.5 | 4.5 |
| | Fatty acid | Barium ricinoleate | — | — | — | 0.25 | — | — |
| | metal salt | Zinc 12- | 0.25 | — | — | — | 0.25 | — |
| | | hydroxystearate | | | | | | |
| | | Zinc laurate | — | 0.25 | — | — | — | 0.25 |
| SP value of first base resin of cover: SP1 ((cal/cm³)^{0.5}) | | | 10 | 10 | 10 | 10 | 10 | 10 |
| SP value of second base resin of fluorescent pigment: | | | 9.9 | 9.9 | 10.7 | 10.7 | 10.7 | 10.7 |
| SP2 ((cal/cm³)^{0.5}) | | | | | | | | |
| Absolute value of difference between SP values: | | | 0.1 | 0.1 | 0.7 | 0.7 | 0.7 | 0.7 |
| (\| SP1 − SP2\|) | | | | | | | | |
| Evaluation | Color tone | L* value | 95.18 | 94.22 | 93.91 | 99.48 | 94.73 | 92.86 |
| | | a* value | −43.1 | −43.4 | −52.7 | −55.4 | −52.7 | −50.5 |
| | | b* value | 109.6 | 108 | 83.21 | 92 | 84.92 | 84 |

| | | | | | | |
|---|---|---|---|---|---|---|
| Color development stability | 1 | 1 | 4 | 4 | 4 | 4 |

The materials used in Table 3 are shown as follows.

Polyurethane resin: Elastollan (registered trademark) NY82A (polyurethane elastomer, polyol component: polytetramethylene ether glycol, polyisocyanate component: dicyclohexylmethane-4,4′-diisocyanate, chain extender: 1,4-butanediol) (Shore A hardness: 82) available from BASF Japan Ltd.

Wax Master VD: lubricant available from BASF Japan Ltd.

JF-90: light stabilizer available from Johoku Chemical Co. Ltd.

Titanium oxide: “A220” available from Ishihara Sangyo Co., Ltd.

EPO Color FP3000: fluorescent pigment having fluorescent dye dispersed and fixed in benzoguanamine resin (condensation product of benzoguanamine and formaldehyde), available from Ukseung Chemical Co., Ltd.

Lumicolor Yellow: fluorescent pigment having fluorescent dye dispersed and fixed in acrylic resin, available from Kashinomoto Technologies Co., Ltd.

FX305: fluorescent pigment having fluorescent dye dispersed and fixed in benzoguanamine resin (condensation product of benzoguanamine and formaldehyde), available from Sinloihi Co., Ltd.

ZQ17: fluorescent pigment having fluorescent dye dispersed and fixed in polyester resin, available from DayGlo Color Corp.

Barium ricinoleate: available from Nitto Kasei Kogyo K.K.

Zinc 12-hydroxystearate: available from Nitto Kasei Kogyo K.K.

Zinc laurate: available from Nitto Kasei Kogyo K.K.

As shown in Table 3, the golf balls No. 1 to 13 are the cases that the absolute value (|SP1-SP2|) of the difference between the solubility parameter value (SP1) ((cal/cm³)^{0.5}) of the base resin of the cover and the solubility parameter value (SP2) ((cal/cm³)^{0.5}) of the base resin of the fluorescent pigment is 6 or less. Each of these golf balls exhibits excellent color development stability. Among them, the golf balls No. 1 to 9 having the absolute value (|SP1-SP2|) of 0.5 or less exhibit particularly excellent color development stability.

This application is based on Japanese Patent application No. 2016-251707 filed on Dec. 26, 2016, the content of which is hereby incorporated by reference.

1. A golf ball comprising a core and a cover covering the core, wherein the cover is formed from a cover resin composition containing a first base resin and a fluorescent pigment,
the first base resin contains at least one resin selected from the group consisting of a polyurethane resin, an ionomer resin and a polyamide resin,
the fluorescent pigment is a dispersion having a fluorescent dye dispersed in a second base resin, and the second base resin contains at least one resin selected from the group consisting of a benzoguanamine resin, an acrylic resin and a polyester resin, and
a constituent member of the golf ball other than the cover does not contain a fluorescent pigment and/or a fluorescent dye.

2. The golf ball according to claim 1, wherein the fluorescent pigment has the fluorescent dye fixed in the second base resin.

3. The golf ball according to claim 1, wherein the fluorescent pigment is contained in an amount of from 1 part by mass to 10 parts by mass with respect to 100 parts by mass of the first base resin.

4. The golf ball according to claim 1, wherein the cover resin composition further contains an ultraviolet absorber or a light stabilizer.

5. The golf ball according to claim 1, wherein the cover resin composition further contains titanium oxide.

6. The golf ball according to claim 1, wherein the first base resin contains the polyurethane resin and the second base resin contains a benzoguanamine resin.

7. A golf ball comprising a core and a cover covering the core, wherein the cover is formed from a cover resin composition containing a first base resin, a fluorescent pigment and a fatty acid metal salt,
the first base resin contains at least one resin selected from the group consisting of a polyurethane resin, an ionomer resin and a polyamide resin,
the fluorescent pigment is a dispersion having a fluorescent dye dispersed in a second base resin, and the second base resin contains at least one resin selected from the group consisting of a benzoguanamine resin, an acrylic resin and a polyester resin, and
a mass ratio of the fatty acid metal salt to the fluorescent pigment (fatty acid metal salt/fluorescent pigment) ranges from 0.01 to 0.20.

8. The golf ball according to claim 7, wherein the fluorescent pigment has the fluorescent dye fixed in the second base resin.

9. The golf ball according to claim 7, wherein the fluorescent pigment is contained in an amount of from 1 part by mass to 10 parts by mass with respect to 100 parts by mass of the first base resin.

10. The golf ball according to claim 7, wherein the cover resin composition further contains an ultraviolet absorber or a light stabilizer.

11. The golf ball according to claim 7, wherein the cover resin composition further contains titanium oxide.

12. The golf ball according to claim 7, wherein the first base resin contains the polyurethane resin and the second base resin contains a benzoguanamine resin.

13. The golf ball according to claim 7, wherein the fatty acid metal salt is contained in an amount of from 0.01 part by mass to 1 part by mass or less with respect to 100 parts by mass of the first base resin.

14. The golf ball according to claim 7, wherein the fatty acid metal salt is a metal salt of a fatty acid having 12 to 30 carbon atoms.

15. The golf ball according to claim 7, wherein the fatty acid metal salt is a metal salt of a fatty acid having a hydroxyl group.

16. The golf ball according to claim 7, wherein the fatty acid metal salt is at least one member selected from the group consisting of a metal salt of lauric acid, a metal salt of ricinoleic acid, and a metal salt of hydroxylstearic acid.
